(19) United States
(12) Patent Application Publication
(10) Pub. No.: US 2006/0289256 A1
(43) Pub. Date: Dec. 28, 2006

(54) Disc brake for a land vehicle

(76) Inventors: Eugen Kloos, Bensheim (DE); Gerhard Berger, Germersheim (DE)

Correspondence Address: Friedrich Kueffner, Suite 910, 317 Madison Avenue, New York, NY, 10017, US

(21) Appl. No.: 11/450,129

(22) Filed: Jun. 10, 2006

(30) Foreign Application Priority Data
Jun. 9, 2005 (DE) 10 2005 026 720.3

(51) Int. Cl. F16D 65/12

(52) U.S. Cl. 188/218 XL

(57) ABSTRACT

A disc brake for a land vehicle has a brake disc and a brake support. A force transmitting device is arranged on only one side of the brake disc for transmitting brake forces from the brake support onto a land vehicle, wherein the force transmitting device has at least two contact surfaces for contacting fixed counter surfaces that are fixed relative to the land vehicle. The two contact surfaces extend transversely to a main plane of the brake disc and are positioned relative to one another at an acute angle, a right angle, an obtuse angle, or an over-obtuse angle. Alternatively, the force transmitting device has at least two screws that extend transversely to an axis of rotation of the brake disc and are positioned relative to one another at an obtuse angle, at a right angle, or at an acute angle.

### BACKGROUND OF THE INVENTION

1. Field of the Invention

The invention relates to a disc brake for a land vehicle. The disc brake comprises a brake support and a brake disc wherein the brake support has only on one side of the brake disc a force transmitting device for transmitting braking forces from the brake support onto the vehicle. The force-transmitting device has at least two contact surfaces each configured to contact a counter surface that is fixed and immobile relative to the vehicle.

The invention concerns in particular a pneumatic and/or electromotorically actuated disc brake whose brake caliper spans at least one brake disc and serves for pressing at least two brake pads by means of an application device against the brake disc.

2. Description of the Related Art

In brake manufacture or vehicle manufacture, the interface between the disc brake and an axle part is usually described as the area where the two aforementioned parts rest flat against one another on one side of the brake disc and are connected to one another by means of screw connections in a force-locking and/or positive-locking way in order to serve, on the one hand, as a securing area and attachment for the disc brake and, on the other hand, to introduce the braking forces occurring during braking into the axle and thus into the vehicle. These areas with the screw connections are subjected to highest loads especially occurring when a braking action takes place and the brake pads are forced against the rotating brake disc. The forces that are caused by this are introduced through the brake pads and their supports as a friction force or a braking forces into the brake support and transferred by its contact areas into the axle part. In the case of a sliding caliper, inner forces of the brake caliper that result from the caliper displacement during the braking action are also present.

In this connection, for example, so-called axial screw connections are known in which the screw axes are positioned perpendicularly to the plane of the brake disc while the interfaces themselves are arranged parallel to the plane of the brake disc. The interface areas are positioned, when Viewed in a plan view, on opposed sides of the brake and/or vehicle axle. Even though the axial screw connections have found wide acceptance within the commercial vehicle industry, special mounting conditions within the vehicle sometimes require different brake attachments.

For example, so-called radial or tangential screw connections are known. In such connections, the contact surfaces are also positioned on one side of the brake disc in those areas that, in a plan view, are located on opposed sides of the axis of rotation of the brake disc and extend in the transverse direction. The aforementioned surfaces are positioned, for example, horizontally and cross the brake and/or wheel axis in an imaginary plane. The screw connections are positioned in a plane that is parallel to the plane of the brake disc.

This type of screw connection is known primarily in the passenger car industry as well as in the two-wheeler industry. However, it can be hardly used or not at all used in connection with commercial vehicles because of the extremely high loads caused by braking moments, brake weights, vibrations when travelling on bad roads etc.

German utility model 1 925 056 discloses a hydraulic fixed caliper disc brake whose housing halves are attached by screws 17 on both sides of the brake disc on a console part 16 spanning the brake disc. The console part that forms an intermediate part serves as an adapter and is attached itself by screw connections 17 to a support 2. The console part therefore represents an auxiliary part. It is subjected, like the screw connections on the horizontal contact surfaces, to high loads. The screw axes are positioned parallel to the plane of the brake disc.

U.S. Pat. No. 4,461,372 illustrates also a fixed caliper 49 that is secured by means of screw connections 74 and intermediate parts 60 to two arms 46, 48 of a fastening part 34 that span the brake disc. The fasting part 34 spans the brake disc. Therefore, the caliper attachment is not realized on only one side of the brake disc. The intermediate parts are auxiliary parts. The fasting part 34 serves as a brake support and is secured by means of through openings 44 to an axle part.

European patent application 1 482 198 A2 shows the attachment of a fixed caliper on a horizontally configured rest of a holding member by means of screws. The screws are screwed into the holding member through the brake caliper. Because of the position of the screw connections, this solution is suitable only for a fixed caliper brake and causes weakening of the caliper because of the correlated through openings. The positive locking action between the contact surfaces has the tendency to suffer from rust creep and requires for its manufacture a high production expenditure. Moreover, the screw connections are also parallel to one another.

The brake according to European patent application 1 482 198 A2 is used primarily on motorcycles. Another fixed caliper disc brake for motorcycles is disclosed in German patent application 102 60 829 A. Moreover, German patent application 198 55 275 A1, Japanese patent application 2001-280377 A, and Japanese patent application 10-331878 A disclose fixed caliper brakes in which the screw connections can be realized from a position radially outwardly through the caliper part because the caliper does not move for compensation of pad wear. The German patent application 10 2004 016 826 A1 published on Oct. 27, 2005, shows another fixed caliper disc brake.

German patent application 102 41 157 A1 shows a disc brake in which the center of gravity of the brake pads arranged on opposed sides of the brake disc are displaced relative to one another.

German utility model 200 21 587 U1 shows a fixed caliper disc brake in which the contact surfaces extend horizontally on both sides of the axis of the brake disc. In this arrangement, the screw connections are subjected to very high stress because of the above described loads during the braking process. The shearing and lateral forces acting on the screw connections in particular are to be counteracted in this configuration in that the brake on the one hand and the axle on the other hand rest positively against one another. This requires a high degree of manufacturing precision. Moreover, the areas of positive connection are prone to rust creep. Also, the screw connections are parallel to one another.

In all of the above described solutions, the contact surfaces are horizontally aligned on opposed sides of an axis and the circumferential forces acting during a braking action are transmitted at the interface only by friction. Accordingly, the screw connections are exposed to increased loads.

### SUMMARY OF THE INVENTION

It is an object of the present invention to further develop a brake of the kind disclosed in U.S. Pat. No. 4,461,372 such that the loads within the interfaces and within the screw connections can be reduced. The loads in question are, for example, the lateral forces and shearing forces resulting from the circumferential forces of the braking action as well as the bending and tilting moments and also environmental effects. Moreover, a simple and inexpensive attachment on the vehicle as well as an automated mounting process should be possible.

In accordance with the present invention, this is achieved in that the two contact surfaces extend transversely to the main plane of the braking disc and are positioned relative to one another at an acute angle, a right angle, an obtuse angle or an over-obtuse (greater than 180° and smaller than 360°) angle.

In other words, it is proposed in accordance with the present invention that the two contact surfaces are positioned in a V-shape relative to one another.

Preferably, the angle between the two contact surfaces is 80° to 170° or 190° to 280°, even more preferred 100° to 140° or 200° to 250°.

This V-shape results in a self-centering action of the brake support or the brake caliper during mounting. Moreover, in accordance with the present invention the circumferential braking force that acts as a tangential force during the braking action is divided into a normal force and into a friction force; the friction force is significantly less than in the afore described prior art solutions so that a significantly reduced total load will result.

The angle between the two contact surfaces is determined generally by computation taking into consideration different parameters such as, for example, the size of the brake, the disc diameter, application forces etc.. In this way, an optimization of the transmission and/or neutralization of moments within the contact surfaces is possible; this not only enables reduction of the required material but also relieves possibly present screw connections off moments, for example, shearing forces.

According to a preferred embodiment of the invention, it is provided that a line of interception of the two planes in which the contact/counter surfaces are positioned coincides with the axis of rotation of the brake disc.

This symmetric solution is suitable for many applications.

Alternatively, it can also be provided in accordance with the present invention that a line of interception of those two elements where the contact/counter surfaces are positioned extends parallel to the axis of rotation of the brake disc but displaced in a direction toward the brake support or in a direction away from the brake support.

Applications are conceivable for such an essentially asymmetric solution also.

The brake support according to the invention can be attached in different ways to the vehicle. According to the invention, it is preferred that at least one of the contact surfaces has at least one recess for receiving a screw.

In other words, screw connections are used.

According to an especially preferred embodiment of the invention, play between the screw and the inner wall of the recess is provided, in particular for compensating tolerances and/or positional variations as long as there is no matching thread provided in the inner wall of the recess. In this case, preferably a play between the screw and the inner wall of a recess provided in the counterpart of the screw connection (for example, the axle body) should be provided.

According to the invention, preferably a fitting bolt and/or a fitting screw are provided.

For further improving the attachment of the brake support on the vehicle, according to another preferred embodiment of the invention it is provided that at least one of the contact surfaces has at least two recesses each receiving a screw.

According to the invention, the two recesses are preferably displaced relative to one another by a first displacement in the direction of the axis of rotation of the brake disc.

In this solution, because of the resulting greater contact surfaces a material accumulation is provided so that local overloads are reduced, for example, within the axle body. Moreover, by means of the first displacement a leverage is generated that counteracts the tilting moments of the brake caliper.

In particular in connection with the contact surfaces that are positioned in a V-shape relative to one another, not only possibly provided fastening devices such as screws are relieved; instead, this has also a positive effect on progress of stress/surface pressure in the material within the attachment area.

According to an especially preferred embodiment of the invention, the two recesses are displaced by a second displacement in the direction transverse to the axis of rotation of the brake disc.

This leads to further mechanical advantages.

Particularly preferred is an embodiment in which the recess that is closer to the brake disc is radially farther away from the axis of rotation of the brake disc than the other recess.

This provides significant advantages in regard to stress neutralization.

According to the invention, it can be provided that the two screws differ in regard to their length.

As a result of this asymmetry, additional mechanical advantages can be obtained.

According to another preferred embodiment of the invention, it is provided that the outer contour of at least one of the contact surfaces is congruent at least partially to the outer contour of the corresponding immobile and fixed counter surface.

In particular in connection with dimensioning in accordance with the required size of the two screw displacements, this provides multiple possibilities for configuring the contact surfaces so as to have an insertion depth as small as possible, i.e., reduced extension in the axial direction in an area that is needed by other vehicle parts, for example, parts of a longitudinal axle.

In particular, a material reduction is possible in this way in those areas of the contact surfaces in which no recesses for fastening devices such as screws are provided.

The outer edge of the brake disc is positioned according to the invention preferably in a projection in the direction of the axis of rotation of the brake disc in the area of the recess or on a radial inner boundary thereof.

In other words, it can be provided that the outer recesses for fastening devices such as screws or their central axes are positioned approximately in the area of the outer disc diameter. In this way, when introducing braking forces, effective lengths of the contact surfaces are provided for minimization of material deformation in the critical load zones without the brake as a whole having to be enlarged excessively.

Preferably, the brake support is positioned on only one side of the brake disc.

In other words, it is provided that the brake support does not surround or span the brake disc but instead is designed, for example, as a plate. In the case of a sliding caliper disc brake, the brake support can serve for attaching the sliding bolt for the caliper.

According to an especially preferred embodiment of the invention, it is provided that a caliper leg at the wheel rim side relative to an actuation-side caliper leg is pivoted in the sense of a rotation in the direction of the preferred rotational direction of the brake disc.

This configuration has great mechanical advantages.

In this connection it is moreover preferred that a device for connecting the caliper leg at the wheel rim side with the actuation-side caliper leg is positioned on the departure side of the disc radially closer to the brake disc than on the approach side of the disc.

This embodiment results again in significant mechanical advantages, in particular, in regard to the compensation of disturbing moments.

In addition to the disc brake described above in detail, the invention provides also a disc brake for a land vehicle, in particular of the aforementioned kind, comprising a brake support and a brake disc, wherein the brake support has a force transmitting device for transmitting braking forces from the brake support onto the vehicle on only one side of the brake disc. The device for transmitting braking forces has at least two screws and the two screws extend transversely to the axis of rotation of the brake disc and are positioned relative to one another at an obtuse angle, a right angle, or an acute angle, preferably an angle of 10° to 100°, even more preferred 40° to 80°.

The brakes according to the invention are preferably brakes for commercial vehicles.

Finally, the invention also provides a brake support for the above described brakes.

### BRIEF DESCRIPTION OF THE DRAWING

In the drawing:

FIG. 1 shows an end view of a brake support of a brake in accordance with a preferred embodiment of the invention, wherein the brake support is mounted on an axle part;

FIG. 2 shows another view of the brake support mounted on the axle part illustrating the brake pad;

FIG. 3 shows a schematic perspective view of the brake support in the direction of arrow III-III of FIG. 1;

FIG. 4 shows a schemetic perspective view of the axle part in the direction of arrow IV-IV of FIG. 1;

FIG. 5 is a schematic plan view onto the brake in a partially mounted state;

FIG. 6 shows the brake according to FIG. 5 but in a view at an angle from the center of the vehicle;

FIG. 7 is a schematic plan view onto parts of the brake;

FIG. 8 is a schematic plan view onto parts of the brake;

FIG. 9 is a schematic perspective view of the brake in a first mounted state;

FIG. 9a is a schematic perspective view of the brake in a second mounted state;

FIG. 10 shows the same view as FIG. 1 but of a different embodiment.

### DESCRIPTION OF THE PREFERRED EMBODIMENTS

An axle part referred to by reference numeral 10 is illustrated in the drawings. This axle part in the illustrated embodiment is a monolithic part of the fixed axle 12 of a land vehicle. However, it can also be a part that is screwed onto the axle. In any case, it is fixedly secured to the vehicle. The axle part 10 has two counter surfaces 14 and 16 that are also secured fixedly relative to the vehicle.

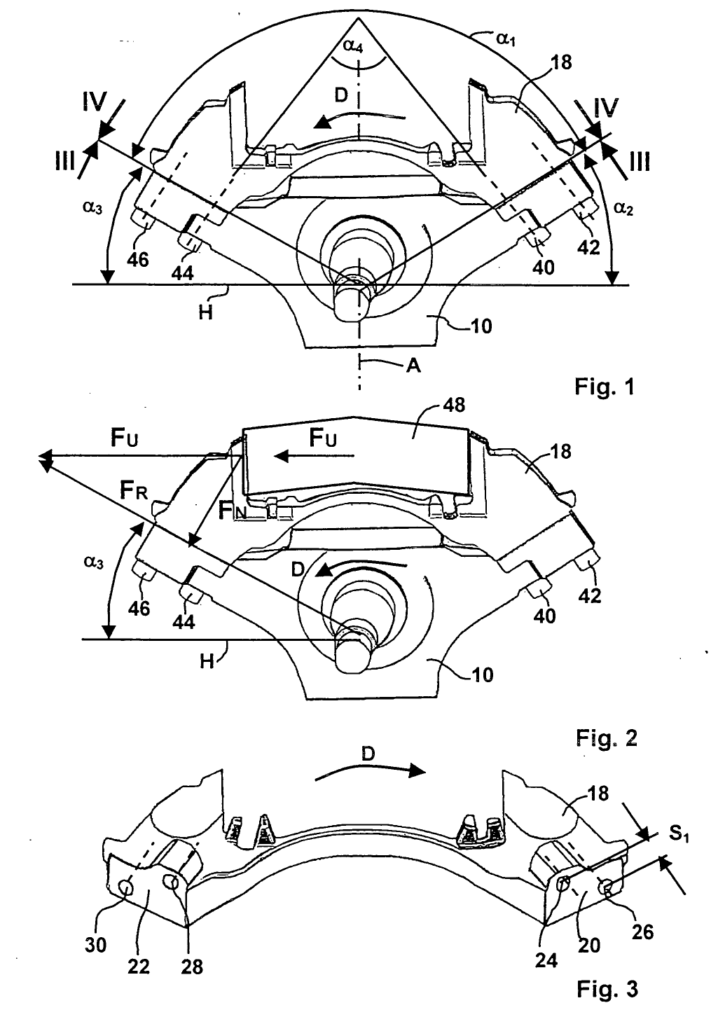

The brake support 18 has contact surfaces 20 and 22. The contact surfaces 20 and 22 are positioned at an angle of, for example, 118° relative to one another. The same holds true for the counter surfaces 14 and 16 of the axle part 10. In the mounted state (FIGS. 1 and 2) the contact surface 20 rests against the contact surface 16 while the contact surface 22 rests against the counter surface 14. This is in accordance with the fact that the same angle α₁ is defined between them, respectively. When the brake illustrated in the Figures is mounted in the so-called 12 o'clock position on the vehicle, the aforementioned contact/counter surfaces are positioned relative to a horizontal line H an angle of, for example, α₂=32° and α₃ 32°.

Those planes in which the contact surfaces 20 and 22 are positioned intercept one another in FIG. 1 somewhat above the axis of rotation A of the brake, i.e., displaced in the direction toward the brake support 18.

In the contact surfaces 20 and 22 of the brake support 18 there are recesses 24, 26, 28, 30; in the illustrated embodiments, they are formed by blind bores provided with threads.

On the axle part 10—in the counter surfaces 14 and 16—there are also recesses; in the illustrated embodiment, they are in the form of through openings 32, 34, 36, 38. When the contact surfaces 20, 22 of the brake support 18 rests against the counter surfaces 16, 14 of the axle part 10, the recesses 24, 36; 26, 38; 28, 32; and 30, 34 are aligned relative to one another, respectively (compare FIG. 7). For attaching the brake support 18 to the axle part 10, screws 40, 42, 44, 46 are provided that are screwed through the through openings 32, 34, 36, 38 into the blind bores 24, 26, 28, 30.

The screws 40, 42, 44, 46 are positioned perpendicularly on the surfaces 14, 16, 20, 22 so that they are positioned relative to one another at an angle α₄ of 62° relative to one another i.e., the adjacent angle to α₁.

When during braking a circumferential force F_{u acts} on a brake pad 48 secured on the brake support 18, it is divided into a friction force F_{R} and a normal force F_{N} because of the geometric conditions so that only the friction force F_{R} exerts a shearing force on the screws 40, 42, 44, 46 while the normal force F_{N} is received directly by the axle part 10. The aforementioned screws are therefore significantly relieved.

In the drawing, the brake disc is referred to by reference numeral 50. Its rotational direction when driving in the forward direction is indicated by arrow D.

As shown in particular in FIG. 7 and FIG. 8, the aforementioned recesses are displaced relative to one another. In the embodiment illustrated in the Figures, between recesses 28, 32 on one side and the recesses 30, 34 on the other side a displacement S₁ in the direction of the brake axis A is realized. Transverse to it, a displacement S₂ is realized; compare FIG. 7.

In the embodiment according to FIG. 8, the same displacement S₂ is provided; in addition, a displacement S₃ with reverse sign in comparison to the displacement S₁ is provided.

In FIGS. 7 and 8, an additional displacement, i.e., displacement V, is shown. This displacement V is an amount by which a caliper leg 52 with brake pad 54 at the wheel rim side is rotated relative to the caliper leg 58 at the actuation side with corresponding brake pad 48. This means that the bridge area 58 connecting the caliper legs 52 and 56 is essentially twisted in order to rotate the caliper leg 52 at the wheel rim side relative to the caliper leg 56 at the actuation side, together with the brake pad, respectively. In this way, the bridge area 58 of the brake caliper, identified as a whole at 60, is radially closer to the brake disc 50 on the departure side of the brake disc than on the approach side.

According to the illustrations of FIG. 7, an extension of the outer rim of the brake disc 50 is approximately tangential to the outer recesses 26, 38 and approximately inside the recesses 30, 34.

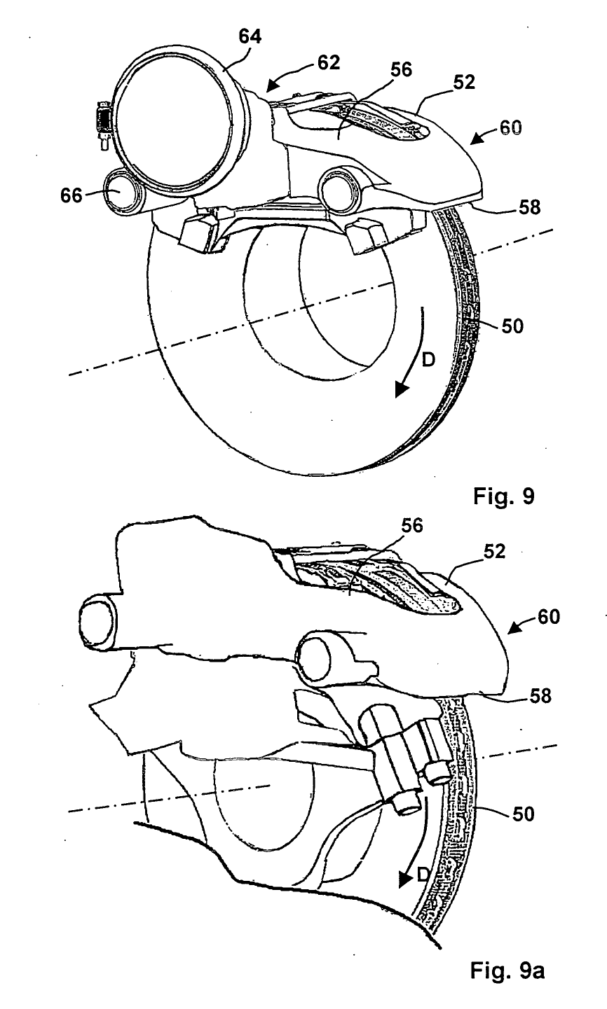

As can be seen in particular in FIG. 9a, the outer contours of the brake support 18 and of the axle part 10 that delimit the contact surfaces 20, 22 and counter surfaces 14, 16, respectively, are partially aligned with one another; this has various advantages. Moreover, they are rounded (see in particular FIG. 3) so that disadvantageous notching effects are prevented.

Also, FIG. 9 shows an application device 62, an actuating cylinder 64 as well as a sliding bolt 66.

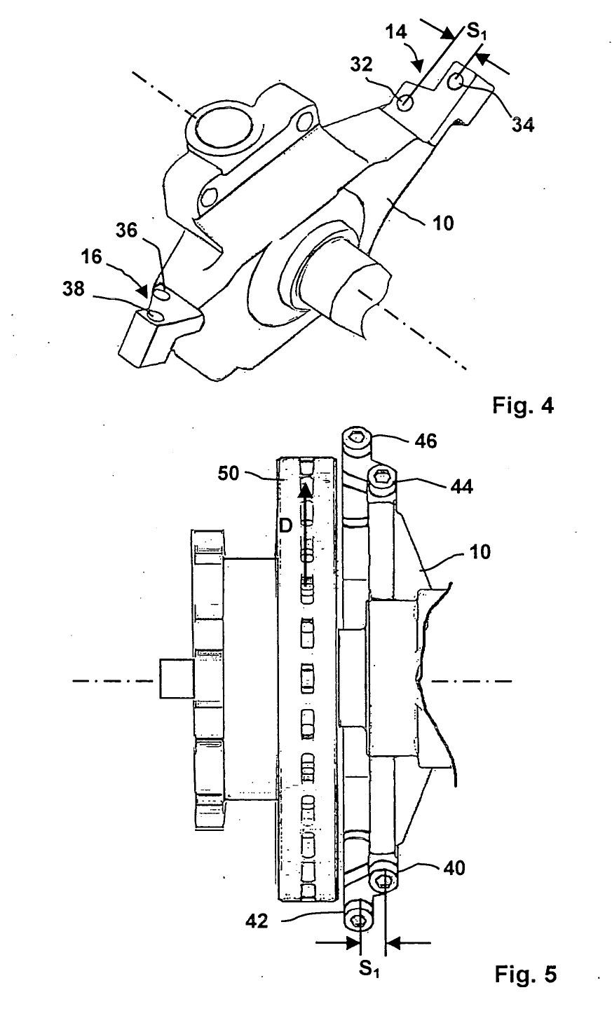

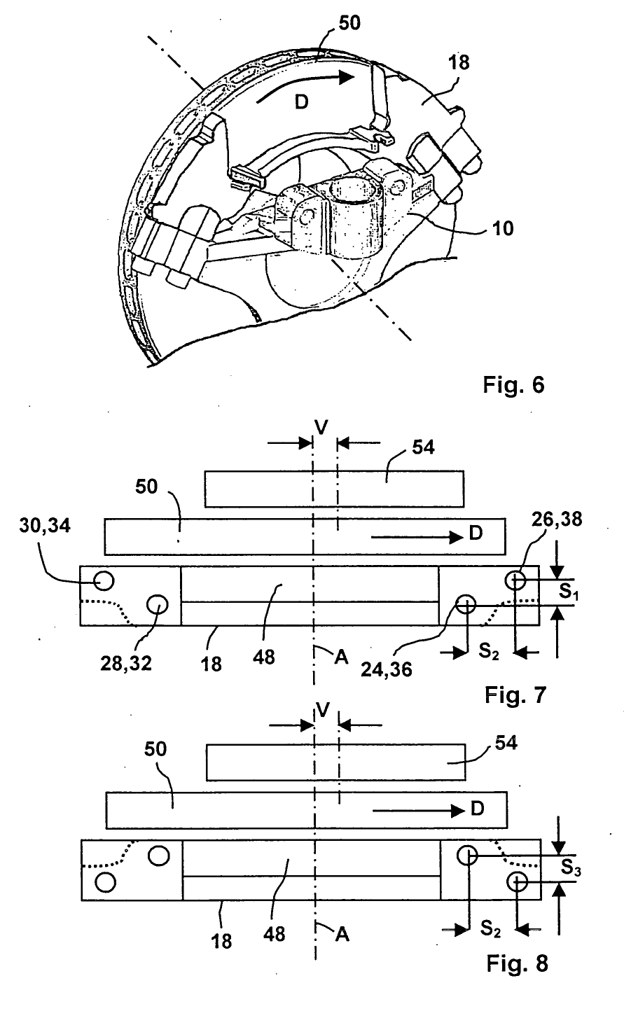

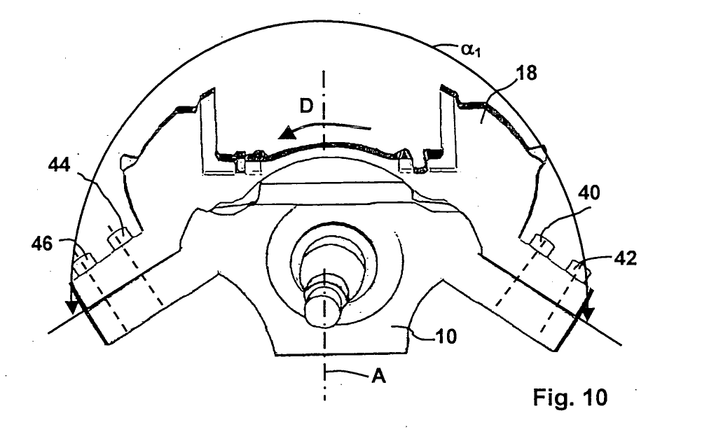

The embodiment according to FIG. 10 differs from that of FIGS. 1 through 9 in that the angle α₁ is an over-obtuse angle of approximately 245°. A further difference of the embodiment according to FIG. 10 in comparison to that of FIGS. 1 through 9 is that in the embodiment of FIG. 10 the screws 40, 42, 44, 46 must be screwed through corresponding through openings in the brake support 18 into the threaded openings in the axle part 10. This arrangement makes them accessible more easily.

The features of the invention disclosed in the above description, the claims, and the drawings can be relevant individually as well as in any combination for realizing the different embodiments of the invention.

While specific embodiments of the invention have been shown and described in detail to illustrate the inventive principles, it will be understood that the invention may be embodied otherwise without departing from such principles.

What is claimed is:

1. A disc brake for a land vehicle, the disc brake comprising:
a brake disc;
a brake support;
a force transmitting device arranged on only one side of the brake disc for transmitting brake forces from the brake support onto a land vehicle, wherein the force transmitting device has at least two contact surfaces for contacting fixed counter surfaces that are fixed relative to the land vehicle;
wherein the two contact surfaces extend transversely to a main plane of the brake disc and are positioned relative to one another at an angle that is acute, right, obtuse, or over-obtuse.

2. The disc brake according to claim 1, wherein the angle between the two contact surfaces is 80°-170° or 190°-280°.

3. The disc brake according to claim 2, wherein the angle between the two contact surfaces is 100°-140° or 200°-250°.

4. The disc brake according to claim 1, wherein a line of interception of planes in which the two contact surfaces are positioned, respectively, coincides with an axis of rotation of the brake disc.

5. The disc brake according to claim 1, wherein a line of interception of planes in which the two contact surfaces are positioned is parallel to an axis of rotation of the brake disc but is displaced in a direction toward the brake support or in a direction away from the brake support.

6. The disc brake according to claim 1, wherein at least one of the two contact surfaces has at least one recess for receiving a screw.

7. The disc brake according to claim 6, wherein an inner wall of the at least one recess has a thread matching a thread of the screw.

8. The disc brake according to claim 6, wherein play is provided between an inner wall of the at least one recess and the screw.

9. The disc brake according to claim 6, comprising at least one of a fitting bolt and a fitting screw.

10. The disc brake according to claim 1, wherein at least one of the two contact surfaces has at least two recesses for receiving a screw, respectively.

11. The disc brake according to claim 10, wherein the at least two recesses are displaced relative to one another by a first displacement in a direction of an axis of rotation of the brake disc.

12. The disc brake according to claim 11, wherein the at least two recesses are displaced relative to one another by a second displacement in a direction transverse to the axis of rotation of the brake disc.

13. The disc brake according to claim 10, wherein a first one of the at least two recesses that is positioned closer to the brake disc is farther away from the axis of rotation of the brake disc than a second one of the at least two recesses.

14. The disc brake according to claim 10, wherein the screws of the at least two recesses have a different length, respectively.

15. The disc brake according to claim 1, wherein an outer contour of at least one of the two contact surfaces at least partially matches an outer contour of a correlated one of the counter surfaces.

16. The disc brake according to claim 1, wherein at least one of the two contact surfaces has at least one recess for receiving a screw, wherein an outer edge of the brake disc in a projection in a direction of an axis of rotation of the brake disc is positioned in an area of the at least one recess or on a radial inner boundary of the at least one recess.

17. The disc brake according to claim 1, wherein the brake support is positioned on only one side of the brake disc.

18. The disc brake according to claim 1, further comprising a brake caliper having a first caliper leg at a wheel rim side of the disc brake and a second caliper leg at an actuation side of the disc brake, wherein the first caliper leg is rotated relative to the second caliper leg in a direction of a preferred rotational direction of the brake disc.

19. The disc brake according to claim 18, wherein the brake caliper has a device connecting the first and second caliper legs, wherein the device is positioned radially closer to the brake disc at the approach side of the brake disc than at the departure side of the brake disc.

20. A disc brake for a land vehicle, the disc brake comprising:
a brake disc;
a brake support;
a force transmitting device arranged on only one side of the brake disc for transmitting brake forces from the brake support onto a land vehicle, wherein the force transmitting device has at least two screws;
wherein the at least two screws extend transversely to an axis of rotation of the brake disc and are positioned relative to one another at an angle that is obtuse, right, or acute.

21. The disc brake according to claim 20, wherein the angle between the at least two screws is 10° to 100°.

22. The disc brake according to claim 21, wherein the angle between the at least two screws is 40° to a 80°.

23. The disc brake according to claim 1 in the form of a commercial vehicle brake.

24. The disc brake according to claim 1 in the form of a caliper disc brake or a sliding caliper disc brake.

25. A brake support for a brake according to claim 1.
